(19) United States
(12) Patent Application Publication
(10) Pub. No.: US 2014/0379110 A1
(43) Pub. Date: Dec. 25, 2014

(54) System and Method for Generating Design Specifications for Custom Equipment

(71) Applicant: Made, LLC, Chicago, IL (US)

(72) Inventor: Shanon R. Marks, Chicago, IL (US)

(21) Appl. No.: 14/305,120

(22) Filed: Jun. 16, 2014

Related U.S. Application Data
(60) Provisional application No. 61/837,625, filed on Jun. 20, 2013.

(51) Int. Cl. G06F 17/50

(52) U.S. Cl. CPC G06F 17/50
USPC 700/97; 703/1

(57) ABSTRACT

A system for generating design specifications for custom equipment may include a data collection unit configured to collect data, wherein collected data is based on one or more attributes related to an activity performed by a user utilizing equipment and a preference engine configured to generate design specifications for custom equipment based on the collected data received from the data collection unit.

### PRIORITY

This application is a non-provisional of, and claims priority from, U.S. Ser. No. 61/837,625 filed on Jun. 20, 2013, the entire contents of which are incorporated herein by reference.

### FIELD

The present disclosure is generally related to equipment design and manufacturing and, more particularly, to a system and method for generating design specifications for manufacturing of custom equipment.

### BACKGROUND

Certain sports or other activities require equipment to be used while performing the activity. Generally, equipment used while performing an activity is manufactured for the “average” user. This is particularly the case related to many water sports, such as surfing, sail boarding, or paddleboarding. Board design may be limited to a few different styles, shapes, and sizes. Even the options available for the equipment may not take into account many parameters related to the user, thus limiting the overall experience and enjoyment of the user.

Customized equipment, particularly in the area of water sports, may be difficult to design and manufacture due to the wide range of user parameters involved in the design of the board and the cost of manufacturing a single board designed for a particular user.

Accordingly, those skilled in the art continue with research and development efforts in the field of custom equipment design.

### SUMMARY

In one embodiment, the disclosed system for generating design specifications for custom equipment may include a data collection unit configured to collect data, wherein collected data is based on one or more attributes related to an activity performed by a user utilizing equipment and a preference engine configured to generate design specifications for custom equipment based on the collected data received from the data collection unit.

In another embodiment, disclosed is a method for generating design specifications for custom equipment, the method may include the steps of: (1) providing a data collection unit and a preference engine configured to collect user data, (2) performing, by a user, an activity utilizing equipment, (3) collecting, by the data collection device, data related to the user, wherein collected data is based on one or more attributes related to the activity performed by the user, (4) transferring the collected data from the data collection unit to the preference engine, (5) processing, by the preference engine, the collected data, and (6) generating, by the preference engine, design specifications for custom equipment.

Other embodiments of the disclosed system and method will become apparent from the following detailed description, the accompanying drawings and the appended claims.

### BRIEF DESCRIPTION OF THE DRAWINGS

FIG. 1 is a block diagram of one embodiment of the disclosed system for generating design specifications for custom equipment;

FIG. 2 is a block diagram of one embodiment of user data collected by the disclosed system;

FIG. 3 is a block diagram of one embodiment of the disclosed data collection unit;

FIG. 4 is an example of one embodiment of a user interface displaying design specifications generated by the disclosed system;

FIG. 5 is an example of one embodiment of a user interface displaying explanation data generated by the disclosed system;

FIG. 6 is an example of another embodiment of a user interface displaying explanation data generated by the disclosed system;

FIG. 7 is an example of another embodiment of a user interface displaying explanation data generated by the disclosed system;

FIG. 8 is a block diagram of another embodiment of the disclosed system; and

FIG. 9 is a flow diagram of the disclosed method for generating design specifications for custom equipment.

### DETAILED DESCRIPTION

The following detailed description refers to the accompanying drawings, which illustrate specific embodiments of the disclosure. Other embodiments having different structures and operations do not depart from the scope of the present disclosure. Like reference numerals may refer to the same element or component in the different drawings.

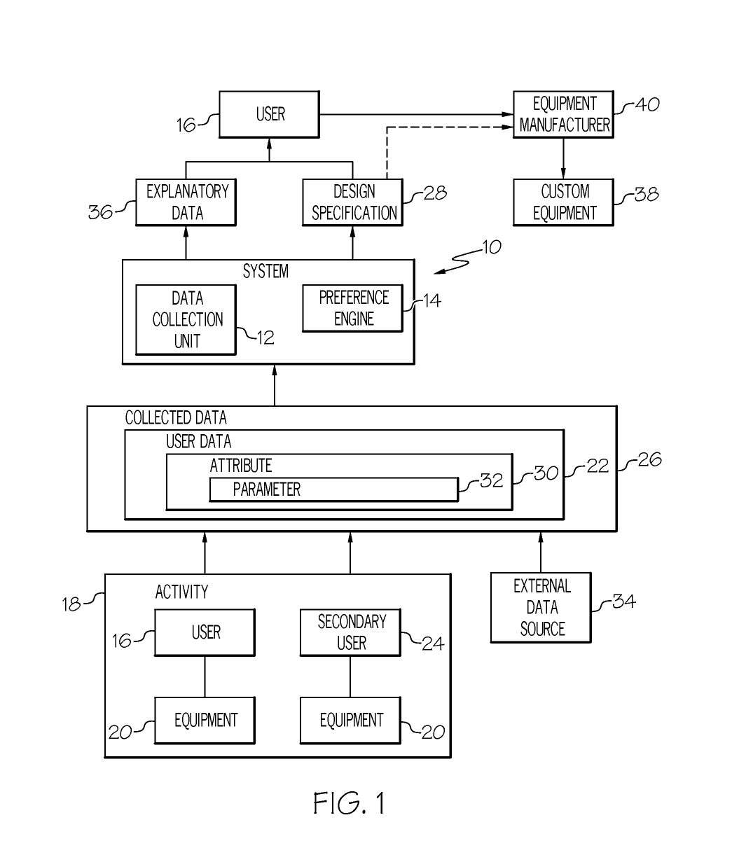

Referring to FIG. 1, disclosed is one embodiment of a system, generally designated 10, for generating recommended design specifications for custom equipment. The system 10 may provide for collection of user data 22 associated with one or more users 16, 24. Collected user data 26 may include information based on one or more attributes 30. Attributes may be based on a user activity 18. Collected user data 26 may be utilized to generate explanatory data 36 related to activity 18 and design specifications 28 for custom equipment 38. Equipment manufacturer 40 may utilize recommended design specifications 28 to design custom equipment 38 specifically for the user 16. Use of explanatory data 36 and custom equipment 38 may provide an improved user experience for the user of the system 10.

As used herein, the user 16 (e.g., a primary user) may include a user of the system 10 for which user data 22 is collected and collected data 26 is processed and utilized to generate design specifications 28 for custom equipment 30. Secondary user 24 may include one or more users of the system 10 for which user data 22 is collected and collected data 26 from the secondary user 24 may be shared with the primary user 16 to generate design specifications 28 for custom equipment 30. Activity 18 may include any activity performed by a user utilizing equipment. For example, activity 18 may include, but is not limited to, surfing, sail boarding, paddleboarding, and the like. Equipment 20 may include any equipment initially utilized by the user while performing activity 18. For example, equipment 20 may include, but is not limited to, a surfboard, a sail board, a kite board, a paddleboard, and the like. Custom equipment 38 may include any equipment customized and manufactured for the user 16 based on recommended design specifications 28 generated by the system 10. For example, custom equipment 38 may include, but is not limited to, a surfboard, a sail board, a kite board, a paddleboard, and the like specifically designed and manufactured for the user 16.

The system 10 may include a data collection unit 12 and a preference engine 14. The data collection unit 12 may, for example, measure data 22 related to activity 18, obtain data 22 related to activity 18, receive input data 22 related to the primary user 16 performing activity 18, and/or obtain data 22 related to one or more secondary users 24 performing activity 18. The preference engine 14 may process collected data 26 and generate design specifications 28 for custom equipment 38.

Design specifications 28 may be utilized by equipment manufacturer 40 to manufacture custom equipment 38 designed specifically for the user 16. Equipment manufacturer 40 may utilize any known manufacturing process to manufacture custom equipment 38. For example, equipment manufacturer 40 may use 3-D printing technology to manufacture high-performance equipment (e.g., surfboard or sail board) having a customized design optimized for the user based on collected data 26. As a specific, non-limiting example, 3-D printing technology may allow equipment manufacturer 40 to produce a board having any shape and/or performance features, for any rider given the rider's age, size, experience level, and other data 22 collected while performing activity 18.

In an example implementation, the system 10 may be associated with one or more users 16 while performing activity 18 utilizing equipment 20. For example, the system 10 may be associated with a single (e.g., primary) user 16. As another example, the system 10 may be associated with a user 16 (e.g., primary user) and one or more secondary users 24. The data collection unit 12 may be utilized for collecting data 22 corresponding to activity 18 performed by the user 16 (and optionally one or more secondary users 24) utilizing equipment 20 and storing and/or transferring collected data 26 to the performance engine 14. The performance engine 14 may be utilized to generate recommended design specifications 28 for custom equipment 38 based on collected data 26.

User data 22 may include information about one or more attributes 30 related to activity 18. Attributes 30 may include any characteristic, quality, or property associated with the user 16, activity 18, equipment 20, and/or one or more secondary users 24. Each attribute 30 may include one or more quantifiable parameters 32. Parameters 32 may include any recognizable or measurable data collected by the data collection unit 12 or obtained by the preference engine 14.

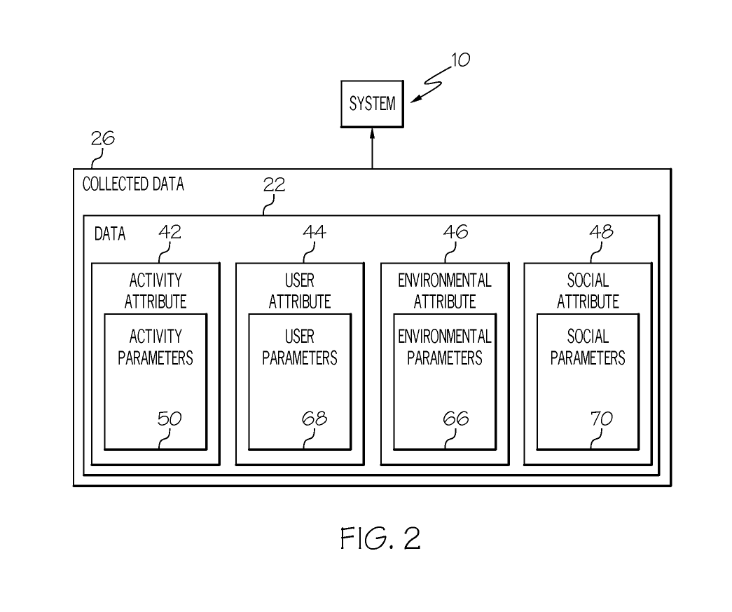

Referring to FIG. 2, in an example implementation, user data 22 may include activity attribute 42, user attribute 44, environmental attribute 46, and/or social attribute 48.

Activity attribute 42 may include one or more activity parameters 50 related to activity 18. As an example where activity 18 is surfing, sail boarding, or paddleboarding, activity parameters 50 may include time of activity (e.g., time on water), time of non-activity (e.g., time stationary), location, path traveled (e.g., track), top speed, average speed, acceleration, duration of a single ride, average length of a plurality of rides, an activity start time, an activity end time, altitude, altitude difference during ride, slope of ride, and the like.

Environmental attribute 46 may include one or more environmental parameters 66 related to environmental factors during performance of activity 18. As an example, environmental parameters 66 may include calendar date, time of day, water temperature, water salinity, wind speed, wind direction, average wind speed, average wind direction, wave height, cloud cover, air temperature, barometric pressure, and the like.

User attribute 44 may include one or more user parameters 68 related to the user 16. For example, user parameters 68 may include user height, user weight, user sex, user age, user skill level, and the like.

Social attribute 48 may include one or more social parameters 70 related to collected data 26 of one or more secondary users 24 (FIG. 1). For example, social parameters 70 may include proximity of other riders, similarity of activity performance of proximate user (e.g., board riders), similarity of age of proximate users, similarity of equipment 20 (e.g., surf board or sail board) of proximate users, similarity of activity, location, time, and/or type of activity (e.g., surfing or sail boarding) of proximate users, and the like.

The data collection unit 12 may be configured to provide one or more features of the system 10, such as collection of user data 22 (e.g., data regarding performance of activity 18, data regarding the user 16, and/or the respective activity environment), processing of collected data 26, and/or providing collected data 26 to the preference engine 14 (e.g., an application, a computer, a server, or a database). The data collection unit 12 may include sensors, systems, or applications for collecting certain user data 22 (e.g., information characterizing parameters 32 of attributes 30).

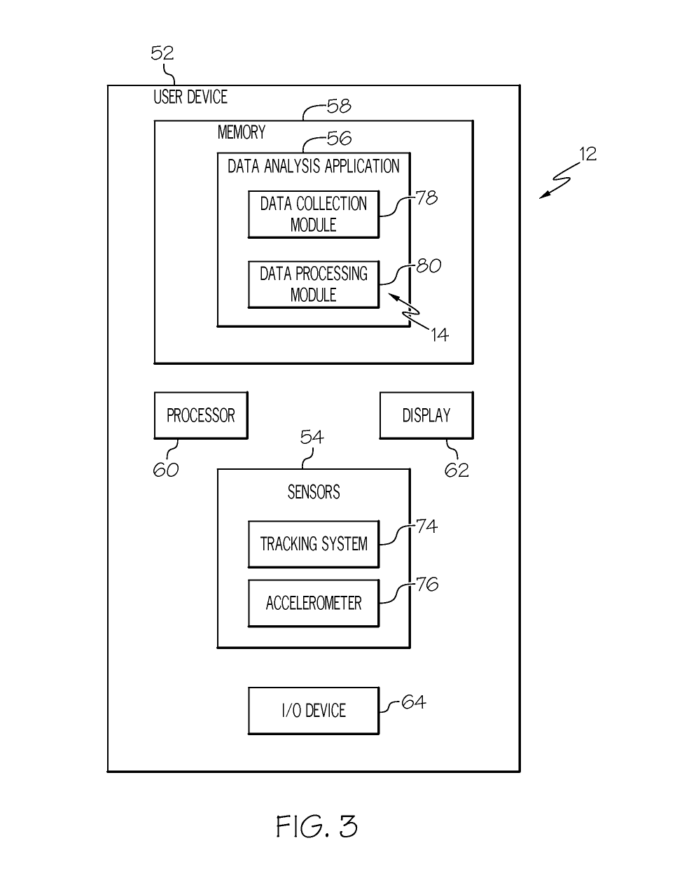

Referring to FIG. 3, an example embodiment of the data collection unit 12 may take the form of a mobile user device 52. The user device 52 may include any type of portable or mobile electronics device, such as for example a smartphone, a cell phone, a mobile telephone, a Global Positioning System (GPS) unit, a personal digital assistant (PDA), a laptop computer, a tablet-style computer, or any other portable electronic device. For example, the user device 52 may be worn or carried by the user 16. In another example, the user device 52 may be connected (e.g., integral) to equipment 20.

In an example implementation, a software application (“APP”) may be provided for the data collection unit 12, such as for operating systems (e.g., such as those employed by iPhone and Android systems). Once the APP is downloaded to the data collection unit 12 (e.g., smartphone) and launched, no additional start/stop activities by the user may be required. The APP may collect data 22 using sensors in the data collection unit 12 (e.g., smartphone) to determine various activity parameters 50, user parameters 68, environmental parameters 66, and/or social parameters 70. The APP and/or any related, required, or useful applications, plug-ins, readers, viewers, updates, patches, or other code for executing the APP may be downloaded via the Internet or installed on the user device 52 in any other known manner.

In an example embodiment, the data collection unit 12 (e.g., the user device 52) may include one or more sensors 54, a data analysis application 56 (e.g., the APP), a memory 58, a processor 62, a display 64, and input/output devices 66. The sensors 54 may collect one or more types of data 22 regarding parameters 32 of one or more attributes 30 (e.g., activity attribute 42 and/or environmental attribute 46).

The memory 58 may store the data analysis application 56 and collected data 26. The memory 58 may include any one or more devices suitable for storing electronic data, (e.g., RAM, DRAM, ROM, internal flash memory, external flash memory cards, and/or any other type of volatile or non-volatile memory or storage device. The data analysis application 56 may be embodied in any combination of software, firmware, and/or any other type of computer-readable instructions.

The processor 62 may include a microprocessor, a microcontroller, a digital signal processor (DSP), an application specific integrated controller (ASIC), electrically-programmable read-only memory (EPROM), or a field-programmable gate array (FPGA), or any other suitable processor or processors, and may be generally operable to execute the data analysis application 56, as well as providing any other functions of the data collection unit 12.

The sensors 54 may include any one or more devices for detecting information regarding activity 18 and/or the environment. For example, the sensors 54 may include a location tracking system 74, such as a Global Positioning System (GPS) unit or any other system or device for tracking the geographic location of the data collection unit 12. As another example, the sensors 54 may include an accelerometer 76 configured to detect acceleration of the data collection unit 12 in one or more directions (e.g., the x, y, and/or z directions). As another example, the sensors 54 may include a compass to provide data to a microprocessor to calculate direction. As still another example, the data collection unit 12 may include sensors, systems, or applications for collecting any data related to environmental attribute 46 and/or activity attribute 42.

Additionally, the data collection unit 12 may collect any data 22 related to user attribute 44 from input devices and/or devices external to the data collection unit 12 (e.g., input/output devices 64). The data collection unit 12 may obtain any or all data 22 related to environmental attribute 46 from external data source 34 (e.g., the Internet). The data collection unit 12 may collect any secondary user data 22 related to social attribute 48 from associated data collection units 12 (e.g., via the APP or similar network).

For example, in one implementation of the data collection unit 12, the APP may utilize sensors 54 in the user device 52 (e.g., smartphone) to automatically begin collecting data 22 once opened. Automated tracking may use algorithms to use the device/server architecture to determine and/or measure various activity parameters 50 (e.g., location, speed, time, altitude, etc.). The APP may be configured to receive user parameters 68 as input (e.g., via an input device). The APP may be configured to obtain various environmental parameters 66 (e.g., weather conditions, water conditions, etc.) based at least in part by the activity parameters 50. Environmental parameters 66 may be collected in real time (e.g., via a mobile network) or may be collected after completion of activity 18 (e.g., via connection to the Internet). The APP may be configured to obtain various social parameters 70 (e.g., proximate users, proximate user performance, etc.) based at least in part by the activity parameters 50. Social parameters 70 may be collected in real time (e.g., via a mobile network) or may be collected after completion of activity 18 (e.g., via connection to the Internet). The APP may be configured so that interaction with the user is limited, such that the APP will run automatically after initial setup. For example, automatic start and stop capabilities may be accomplished using device sensors.

The display 62 may include any type of display device for displaying information related to the data analysis application 50, such as a graphical display of collected data 26 in the form of explanatory data 36 (e.g., graphs and/or charts) or design specifications 28 (e.g., virtual prototype). For example, the display 62 may be an LCD screen (e.g., thin film transistor (TFT) LCD or super twisted nematic (STN) LCD), an organic light-emitting diode (OLED) display, or any other suitable type of display. In some embodiments, the display 64 may be an interactive display (e.g., a touch screen) that allows a user 16 to interact with the data analysis application 56. In other embodiments, the display 64 may be strictly a display device, such that all user input is received via other input/output devices 64.

The input/output devices 64 may include any suitable interfaces allowing a user 16 to interact with the data collecting unit 12, and in particular, with the data analysis application 56. For example, the input/output devices 64 may include a touch screen, physical buttons, sliders, switches, data ports, keyboard, mouse, voice activated interfaces, or any other suitable devices.

The data analysis application 56 may be described in terms of functional modules, each embodied in a set of logic instructions (e.g., software code). Code may be stored in non-transitory computer readable medium in the modules and may be executable by the processor 60 to perform functions.

For example, as shown in FIG. 3, the data analysis application 56 may include a data collection module 78 and a data processing module 80. The data collection module 78 may be operable to manage the collection of user data 22. The data collection module 78 may collect data 22 from any number and types of data sources, including data sources provided by the data collection unit 12 (e.g., data collected from sensors 54 related to activity attribute 42 and/or environmental attribute 46), data sources external to the data collection unit 12 (e.g., data obtained from external data sources 36 related to environmental attribute 46 and/or social attribute 48), and/or data sources external to the data collection unit 12 (e.g., data input by the user 16 related to user attribute 42).

Further, data collection module 78 may also initiate and/or manage the storage of any collected data 26 associated with the data analysis application 56, including raw data 22 or filtered/processed data collected by data collection unit 12 and/or any of the metrics or other data calculated or processed by the data processing module 80, such that the collected data 26 may be subsequently accessed (e.g., for display or further processing). For example, the data collection module 78 44 may manage short-term storage of user data 22, such as in volatile memory and may manage long-term storage of collected data 26 or processed data (e.g., explanatory data 36 and/or design specifications 28), such as in non-volatile memory.

The data collection module 78 may collect data 22 over one or more activity sessions. As used herein, an activity session may refer to any period of performing activity 18, which may include a single ride, a portion of a ride, or a series of multiple distinct rides.

Any or all data 22 collected by the data collection module 78 may be time stamped (e.g., time and date), either by the data collection module 78 itself or by another device that collected or processed particular data (e.g., data related to environmental attribute 48 and/or social attribute 48 received from external data source 34) before receiving the data by the data collection module 78. Time stamping may allow for data 22 from different sources (e.g., data from sensors 54 and data from external data sources 34) to be synchronized for analyzing the collected data 26 together as a whole.

In an example embodiment, the data processing module 80 may be operable to process and/or analyze any of the collected data 26 collected by the data collection unit 12 itself and/or collected by external devices or sources (e.g., external data source 34) and communicated to the data collection unit 12. Based on the collected data 26, the data processing module 80 may generate design specifications 28 for custom equipment 38 (FIG. 1). For example, the data processing module 80 may function as the preference engine 14 for the system 10 (FIG. 1). Based on the collected data 26, the data processing module 80 may generate recommended design specifications 28 for custom equipment 38. Further, based on the collected data 26, the data processing module 80 may calculate one or more user behavior metrics based on one or more activity sessions in the form of explanatory data 36.

For example, the data analysis application 56 (e.g., the APP) may process any or all of data 22 collected by data collection unit 12 and/or data 22 received by the data collection unit 12 from external sources and generate recommended design specifications 28 for custom equipment 38 based on collected data 26. In an example implementation, the data processing module 80 may process collected data 26 provided by the data collection module 78 (e.g., measured or received by the sensors 54 related to activity parameters 50, received as input related to user parameters 68, received by the sensors 54 or obtained by an external data source 34 related to environmental parameters 66, and/or obtained by an external device related to social parameters 70).

The data analysis application 56 may further weigh collected data 26. For example, data processing module 80 may apply algorithms that generate recommended design specifications 28 for custom equipment 38 (FIG. 1) based on weighted values for each respective attribute 30 and/or each respective parameter 32. For example, data 22 related to user attribute 42 (e.g., user weight, user height, user skill level) may have a greater impact on recommended design specifications 28 than data 22 related to social attribute 48 or environmental attribute 46.

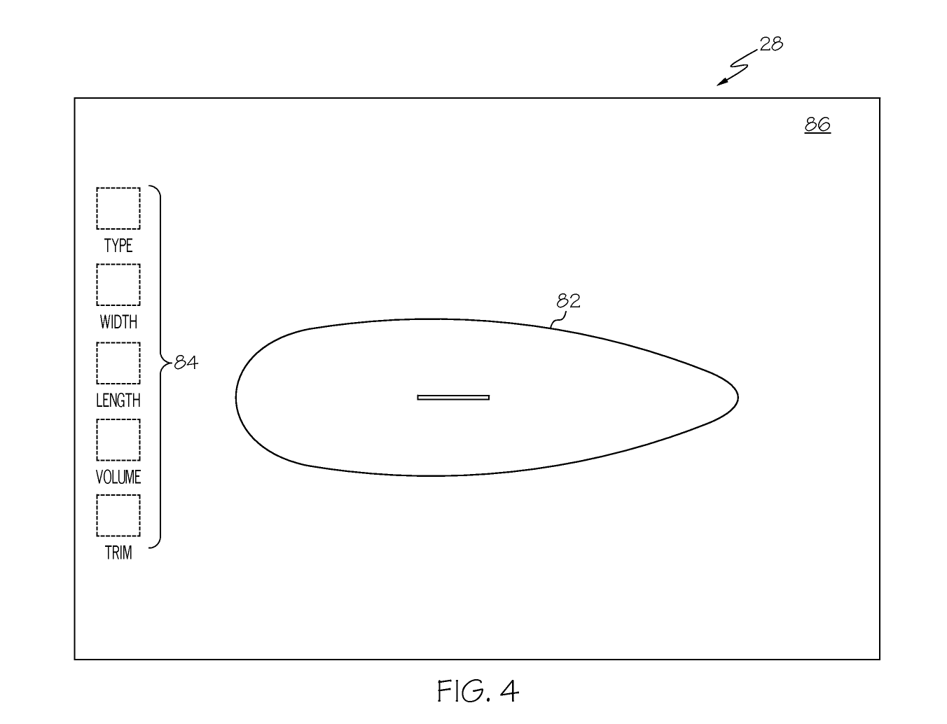

Referring to FIG. 4, the design specifications 28 may be displayed by the data analysis application 56 in graphical form as a user interface 86, for example via the display 62 of the user device 52 (FIG. 3). For example, the design specification 28 may be displayed in the form of a virtual prototype 82 and/or as design specification values 84. The virtual prototype 82 may visually depict the physical form of custom equipment 38. The design specification values 84 may include, but are not limited to, the type of equipment (e.g., surf board, sail board, or paddleboard), the dimensional width of the board, the dimensional length of the board, the volume of the board, the trim of the board, the style of board, and/or the recommended experience level of a user of the board.

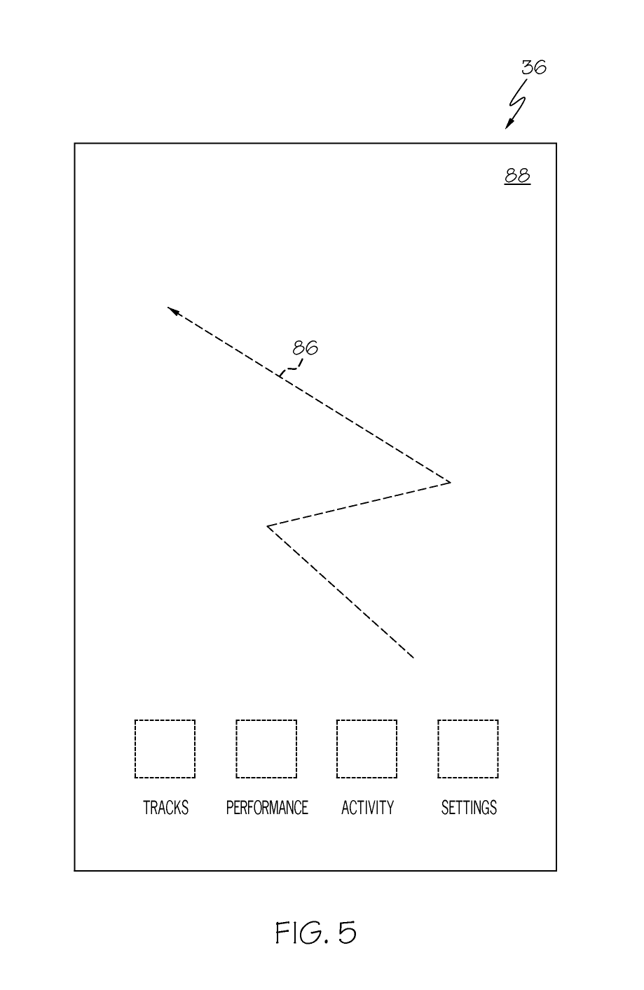

Referring to FIGS. 5-7, the explanatory data 36 may be displayed by the data analysis application 56 in graphical form as a user interface 86, for example via the display 62 of the user device 52 (FIG. 3). For example, the data processing module 80 may display user (e.g., rider) metrics for location, path of travel, duration, acceleration, speed, altitude difference, etc. based on data collected related to activity attribute 42. Further, data processing module 80 may apply weather conditions and/or water conditions based on data collected related to environmental attribute 46. Further, the data processing module 80 may provide information related to one or more activity sessions of one or more secondary users 24.

As illustrated in FIG. 5, an example user interface 88 (e.g., a track screen) may visually depict track data 86 (e.g., the path of the ride) of one or more activity sessions. Geographic location data (e.g., collected from sensors 54) may also be shown (e.g., overlaid), such as by a map, to provide context to the visual track data 86. Additionally, weather and water condition data (e.g., collected from sensors 54 or external data source 34) may also be shown (e.g., overlaid) to provide context to the visual track data 86.

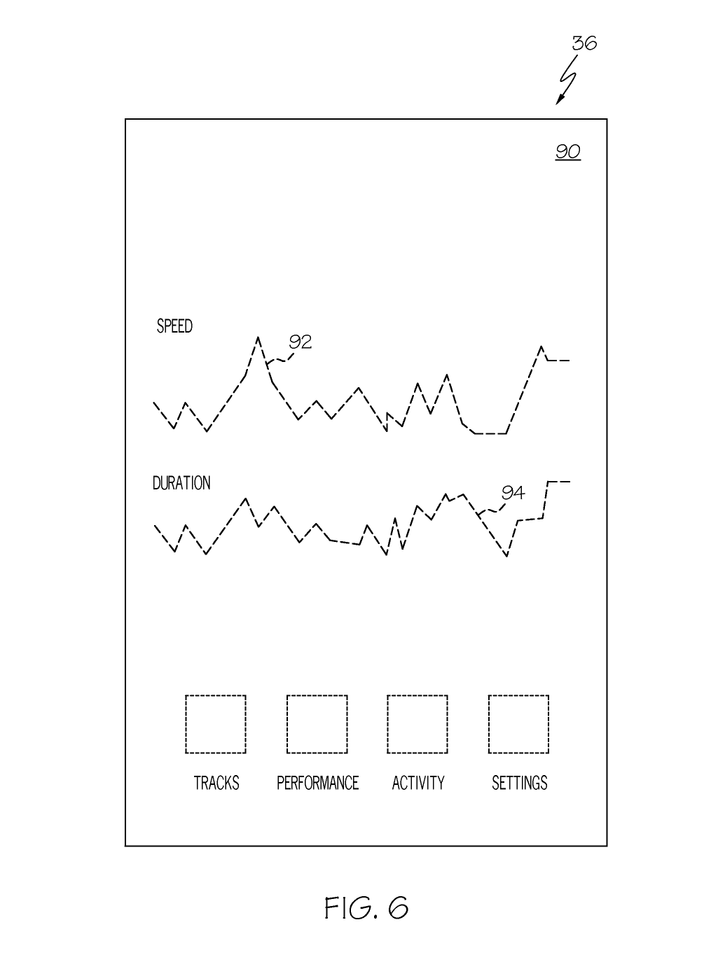

As illustrated in FIG. 6, an example user interface 90 (e.g., performance screen) may visually depict speed data 92 over time, duration data 94 (e.g., collected from sensors 54) in graphical form. Explanatory data 36 may be displayed as any visual or graphical depiction of collected data 26 (FIG. 1) related to any measurable attribute (e.g., activity attribute 42). For example, while not shown, explanatory data 36 may be displayed graphically for average speed over time, acceleration over time, altitude over time, length of ride, wind speed over time, wave height over time, and the like.

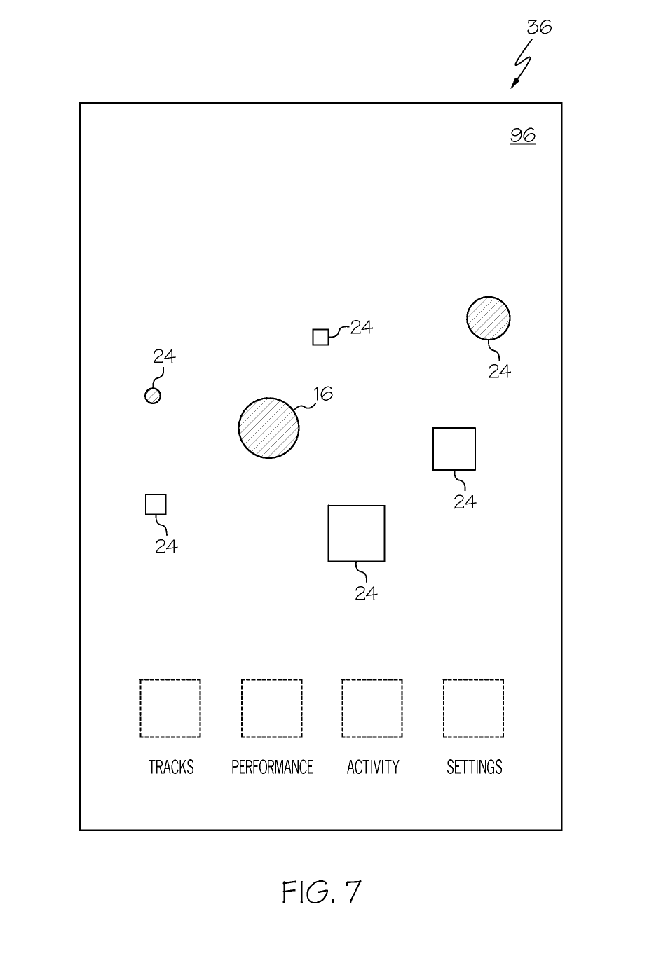

As illustrated in FIG. 7, an example user interface 96 (e.g., social screen) may visually depict one or more secondary users 24 that performed activity 18 proximate secondary users 24 (e.g., secondary users 24 within a set or pre-set boundary relative to the location of primary user 16). The user interface 96 may provide access to graphical displays of performance (e.g., activity attribute 42) for the secondary users 24. The user interface 96 may identify secondary users 24 relevant to the user 16. For example, secondary users 24 utilizing similar equipment 18 may be shown as having the same icon (e.g., shape) as the icon depicting the user 16. As another example, secondary users 24 having similar data related to one or more attributes 30 may be shown having an icon dimension closely sized to the icon depicting the user 16. Additionally, the APP (e.g., via the user interface 96) may provide for communication and integration with social networking websites (e.g., Twitter and Facebook).

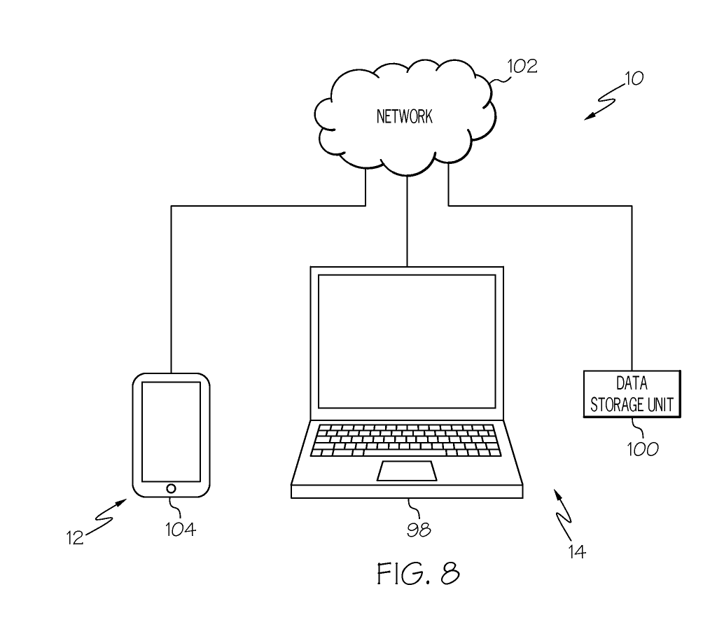

Referring to FIG. 8, in another example embodiment of the system 10, the data collection unit 12 may take the form of a mobile user device 104. The data collection unit 12 may share collected data 26 (FIG. 1) with other external systems of devices. The data collection unit 12 may be communicatively connected to one or more remote computers 98 and/or remote data storage systems 100 via one or more networks 102. The user device 104 may be substantially similar to the user device 52 described above and referenced in FIG. 2. The data processing module 80 (FIG. 2) may alternatively or in addition to communicate collected data 26 collected by the data collection unit 12 (FIG. 1) via a network or other communication link to one or more other computer devices (e.g., for display by remote computers 98 and/or for storage in a remote data storage system 100).

Computers 98 may include any one or more devices operable to receive collected data 26 from the data collection unit 12 and further process and/or display the collected data (e.g., mobile telephones, personal digital assistants (PDA), laptop computers, desktop computers, servers, or any other device). In some embodiments, the computer 98 may include any suitable application or applications for interfacing with the data collection unit 12 (e.g., with the data analysis application 56 on the user device 104), which may be downloaded via the Internet or otherwise installed on the computer 98.

In some embodiments, one or more computers 98 may be configured to perform some or all of the function of the preference engine 14 (FIG. 1), such as those discussed above with respect to the data processing module 80 of the user device 52. For example, the data collection unit 12 may communicate some or all of collected data 26 collected by the data collection unit 12 (e.g., raw data 22, filtered data 26, or otherwise partially processed data) to the remote processing computer 98. The computer 98 may process (or further process) the received collected data 26 (e.g., by performing any or all of the data processing discussed above with respect to the data processing module 80, and/or additional data processing.

After processing the data, the computer 98 may then communicate the processed data back to data collection unit (e.g., for storage and/or display), to other remote computers (e.g., for storage and/or display), and/or to the remote data storage 100. The data processing and communication of collected data 26 by the computer 98 may be performed in real time or at any other suitable time. In some embodiments, the computer 98 may process collected data 26 from the data collection unit 12 and communicate the processed data (e.g., in the form of explanatory data 36 and/or design specifications 28) back to the data collection unit such that the data may be displayed by the user device 104 substantially in real time, or alternatively at or shortly after (e.g., within seconds of) the completion of a data collection session.

Using one or more computers 98 to perform some or all of the processing of the collected data 26 may allow for more processing resources to be applied to the collected data 26 (e.g., providing for faster or additional levels of data processing), as compared to processing the collected data 26 by data collection unit as discussed above with respect to the user device 52. Further, using one or more computers 98 to perform some or all of the data processing may free up processing resources of the data collection unit 12, which may be advantageous.

The remote data storage devices 100 may include any one or more data storage devices for storing driving collected data 26 received from the data collection unit 12 (e.g., user device 104) and/or the computer 98. The remote data storage device 100 may include any one or more devices suitable for storing electronic data (e.g., RAM, DRAM, ROM, flash memory, and/or any other type of volatile or non-volatile memory or storage device). The remote data storage device 100 may also include any suitable application or applications for interfacing with the data analysis application 56 of the data collection unit 12 (e.g., stored on the user device 104) and/or with relevant applications on the computers 98.

The network 102 may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet, a mobile network, a cellular network, or any other appropriate architecture or system that facilitates the communication of signals and/or data via any one or more wired and/or wireless communication links. The network 102 may include any communication link known, including for example, cloud, cellular or satellite transmission, magnetic or optical media, radio frequency transmission, microwave or fiber optic transmission, or communications via Internet, cable, or satellite providers.

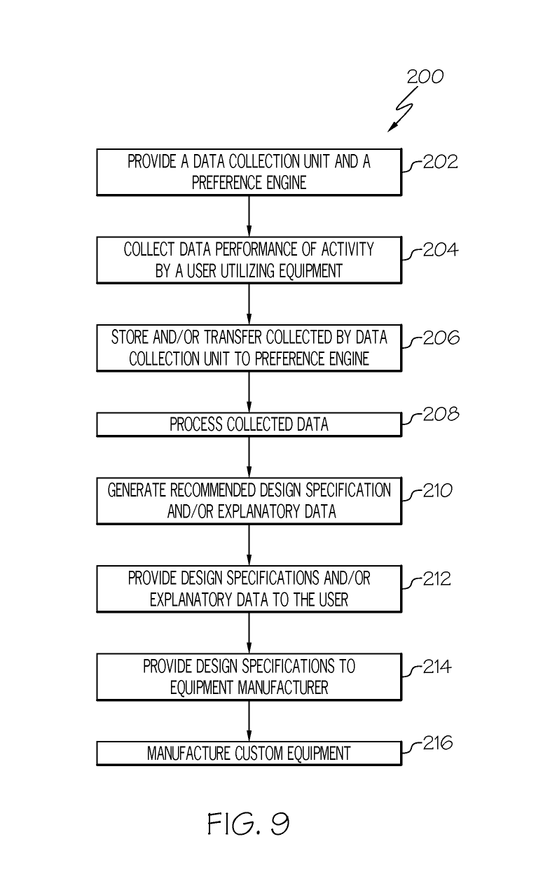

Referring to FIG. 9, also disclosed is a method, generally designated 200, for generating design specifications for custom equipment, with reference to FIGS. 1, 3, and 8.

As shown at block 202, a data collection unit 12 and a preference engine 14 (FIG. 1) may be provided. The data collection unit 12 may be configured to collect data 22 and process collected data 26 (FIG. 1). User data 22 may be during performance of activity 18 (e.g., surfing or sail boarding). The user 16 may perform activity 18 utilizing equipment 20 (e.g., surf board or sail board). The data collection unit 12 may be worn or carried by the user 16 or may be connected to equipment 20.

For example, the user 16 may desire a custom surfboard (e.g., custom equipment 38) be manufactured. The user 16 may utilize the disclosed system 10 by carrying the data collection unit 12 while surfing (e.g., activity 18). The user 16 may surf (e.g., performing one or more rides) using an initial surfboard (e.g., equipment 20).

As shown at block 204, the data collection module 78 (FIG. 3) of the data collection unit 12 may collect data 22 during one or more activity sessions utilizing equipment 20 (e.g., which may correspond to a ride on a board). Data 22 may be collected by one or more sensors 54 or from one or more external data sources 34. The collected data 26 may include data 22 (e.g., information) for one or more parameters 32 related to one or more attributes 30.

For example, the user 16 may initially input data for one or more user parameters 68 associated with user attribute 44. The user 16 may input the user's weight (e.g., 182 kilograms), the user's height (e.g., 86 centimeters), the user's age (e.g., 28) and the user's gender (e.g., male).

During the activity session (e.g., one or more rides), the data collection unit 12 may collect data 22 for one or more activity parameters 50 associated with activity attribute 42. The data collection unit 12 may measure (e.g., via one or more sensors 54) a session time duration (e.g., 1.5 hours), an average board speed (e.g., 11 knots), an average ride duration (e.g., 20 seconds), a top speed (e.g., 22 knots), and may track the path of the ride.

During the activity session, the data collection unit 12 may collect data 22 for one or more environmental parameters 66 associated with environmental attribute 46. The data collection unit 12 may measure (e.g., via one or more sensors 54) and/or obtain (e.g., via external data source 34) an average wind speed (e.g., 12.5 knots), a wind direction (e.g., 180 degrees), a wave height (e.g., 0.6 meters), an altitude (e.g., 500 feet), the calendar date, water conditions (e.g., salinity), cloud cover (e.g., quantified on a scale ranging between 0 and 5 representing clear to overcast), and precipitation (e.g., quantified on a scale ranging from 0 and 5 representing no precipitation to heavy rain).

As shown at block 206, following completion of the activity session, collected data 26 may be stored and/or transferred to the preference engine 14.

As shown at block 208, the preference engine 14 (FIG. 1) may process or analyze any or all collected data 26 collected by the data collection unit 12 (block 204). In some embodiments, the data processing module 80 (FIG. 3) may perform all of the functions of the preference engine 14. In other embodiments, the data processing module 80 may perform some of the functions of the preference engine 14 and a remote processing computer 98 (FIG. 8) may perform some of the functions of the preference engine 14. In still other embodiments, the remote processing computer 98 may perform all of the functions of the preference engine 14.

As shown at block 210, the preference engine 14 may generate recommended design specifications 28 for custom equipment 38 and/or explanatory data 36 (FIG. 1). Design specifications 28 may include any design specification, data, value, or information related to the manufacture of custom equipment 38, as explained above. Explanatory data 36 may include any visual depiction of collected data 26 (e.g., processed data) related any attribute 30 associated with or characterizing the user 16, activity 18, or one or more secondary users 24, as explained above.

For example, design specifications 28 may recommend a surfboard having a certain style and certain characteristics for the user 16. The design specifications 28 may recommend a board having a particular length or range of lengths (e.g., 240, 250, or 260 centimeters), a particular width or range of widths (e.g., 75, 85, 95 centimeters), and/or a particular volume or range of volumes (e.g., 150, 160, 170 cubic centimeters). Additionally, the design specifications may recommend a user skill level (e.g., quantified on a scale ranging from 0 and 10 representing no experience to expert surfer). Further, for examples where custom equipment 38 may be a sail board, the design specifications 28 may include a type, style, and size of sail.

As shown at block 212, design specifications 28 and explanatory data 36 may be provided to the user 16 (FIG. 1). In some embodiments, design specifications 28 and explanatory data 36 may be displayed (e.g., in graphical or other visual format) by the data collection unit 12 (e.g., user device 52) (FIG. 3). In other embodiments, design specifications 28 and explanatory data 36 may be displayed by the remote processing computer 98 (FIG. 8). In other embodiments, design specifications 28 and explanatory data 36 may be displayed by both the data collection unit 12 (e.g., user device 104) and remote processing computer 98 (FIG. 8).

As shown at block 214, design specifications 28 may be provided to equipment manufacturer 40 (FIG. 1). Design specifications 28 may be provided to equipment manufacturer 40 directly from preference engine 14 (e.g., via remote processing computer 98) or from the user 16 (e.g., via transfer from the data analysis application 56) (FIG. 3).

As shown at block 216, equipment manufacturer 40 may manufacture custom equipment 38 based on collected data 26 processed by the preference engine 14 (e.g., utilizing design specifications 28).

Although various embodiments of the disclosed system and method for generating design specifications for custom equipment have been shown and described, modifications may occur to those skilled in the art upon reading the specification. The present application includes such modifications and is limited only by the scope of the claims.

What is claimed is:

1. A system for generating design specifications for custom equipment, said system comprising:
a data collection unit configured to collect data, wherein collected data is based on one or more attributes related to an activity performed by a user utilizing equipment; and
a preference engine configured to generate design specifications for custom equipment based on said collected data received from said data collection unit.

2. The system of claim 1 wherein said data collection unit comprises one or more sensors configured to measure one or more parameters of said one or more attributes.

3. The system of claim 2 wherein said data collection unit comprises a data collection module implemented by a non-transitory computer readable storage medium.

4. The system of claim 3 wherein said data collection module is configured to receive data from said one or more sensors.

5. The system of claim 3, wherein said data collection unit is configured to obtain data from one or more external data sources.

6. The system of claim 1 wherein said preference engine comprises a data processing module.

7. The system of claim 6 wherein said data processing module is implemented by a non-transitory computer readable storage medium.

8. The system of claim 1 wherein said data collection unit and said preference engine are implemented in combination by a user device.

9. The system of claim 1 wherein said data collection unit is implemented by a user device and said preference engine is implemented by one or more remote processing computers.

10. The system of claim 1 wherein said one or more attributes comprises at least one of activity attribute, user attribute, environmental attribute, and social attribute.

11. A method for generating design specifications for custom equipment, said method comprising:
providing a data collection unit and a preference engine configured to collect user data;
performing, by a user, an activity utilizing equipment;
collecting, by said data collection device, data related to said user, wherein collected data is based on one or more attributes related to said activity performed by said user;
transferring said collected data from said data collection unit to said preference engine;
processing, by said preference engine, said collected data; and
generating, by said preference engine, design specifications for custom equipment.

12. The method of claim 11 further comprising providing said design specifications to said user.

13. The method of claim 11 further comprising:
providing said design specifications to equipment manufacturer; and
manufacturing, by equipment manufacturer, said custom equipment based at least in part on said design specifications.

14. The method of claim 11 wherein said one or more attributes comprises at least one of activity attribute, user attribute, environmental attribute, and social attribute.
